(19) United States
(12) Patent Application Publication
(10) Pub. No.: US 2017/0144238 A1
(43) Pub. Date: May 25, 2017

(54) GEAR TEETH PHASE CALCULATION DEVICE, GEAR TEETH PHASE CALCULATION METHOD, AND GEAR MACHINING APPARATUS

(71) Applicant: MITSUBISHI HEAVY INDUSTRIES MACHINE TOOL CO., LTD., Shiga (JP)

(72) Inventor: Koh ISHII, Minato-ku, Tokyo (JP)

(73) Assignee: MITSUBISHI HEAVY INDUSTRIES MACHINE TOOL CO., LTD., Shiga (JP)

(21) Appl. No.: 15/120,026

(22) PCT Filed: Mar. 16, 2015
(86) PCT No.: PCT/JP2015/057637

§ 371 Date: Aug. 18, 2016

(30) Foreign Application Priority Data
Mar. 20, 2014 (JP) 2014-057400

(51) Int. Cl. B23F 5/04; B23F 23/00; B23F 23/12

(52) U.S. Cl. CPC B23F 5/04; B23F 23/1218; B23F 23/006

(57) ABSTRACT

The present invention improves the calculation accuracy of the phase of gear teeth. This method for calculating a phase of teeth of a gear, the gear having Z number of teeth, includes: a gear teeth amplitude signal acquiring step of acquiring a gear teeth amplitude signal (S(c)) corresponding to at least one revolution of the gear, the gear teeth amplitude signal (S(c)) being formed by an association of an angle (c) of the gear and a value corresponding to irregularities on an outer circumference of the gear within the angle (c); a phase calculating step of calculating a phase (B) of an angular pitch (P) of the gear in accordance with the number (Z) of teeth when the gear teeth amplitude signal (S(c)) is subjected to frequency decomposition; and a gear meshing angle calculating step of calculating a gear meshing angle on the basis of the phase (B) detected by the phase calculating unit.

### TECHNICAL FIELD

The present invention relates to a gear teeth phase calculation device, a gear teeth phase calculation method, and a gear machining apparatus. In particular, the present invention relates to a gear teeth phase calculation device, a gear teeth phase calculation method, and a gear machining apparatus that machines a gear on the basis of a phase of teeth of the gear detected by the device and the method.

### BACKGROUND ART

To reduce gear noise and the like, a gear subjected to gear cutting by a gear cutting machine is finish-ground by a finish-grinding process, which corrects a gear cutting error. In the finish-grinding process, it is necessary to determine a phase of crests and troughs of the teeth of a workpiece gear and perform phase matching, such that teeth of a grinding tool, such as a threaded grindstone, mesh with the workpiece gear at a predetermined phase.

As an example of the above-described method for determining the phase of the crests and troughs of the gear in a reference direction of the workpiece gear, Patent Document 1 discloses a method for detecting a left tooth surface and a right tooth surface of a gear with a displacement sensor and performing phase matching of the teeth of the gear on the basis of a sensor signal output by the displacement sensor.

### CITATION LIST

### Patent Document

Patent Document 1: Japanese Unexamined Patent Application Publication No. 2008-110445A

### SUMMARY OF INVENTION

### Technical Problem

Here, the method disclosed in Cited Document 1 will be described in more detail. In the method disclosed in Cited Document 1, first, on the basis of the sensor signal output from the displacement sensor, an angle of the left tooth surface and an angle of the right tooth surface for each of the teeth of the workpiece gear are determined. With Z representing the number of the teeth of the workpiece gear, each of the teeth is identified as a tooth number j (from 0 to Z−1). Since the number of teeth is Z, an angle between the left tooth surfaces of the adjacent teeth and an angle between the right tooth surfaces of the adjacent teeth both become 360/Z in theory.

Then, a cumulative pitch error e[k] is calculated, which is a difference between the angle of the left tooth surface of each of the teeth and the theoretical angle of the left tooth surface or a difference between the angle of the right tooth surface of each of the teeth and the theoretical angle of the right tooth surface calculated taking the tooth with the tooth number 0 as reference. Assuming that the angle of the left tooth surface of the tooth number j is C[2j], and the angle of the right tooth surface is C[2j+1], the cumulative pitch error e[k] can be calculated using the following formulas:

C[2j]=C[0]+j*360/Z+e[2j]

C[2j+1]=C[1]+j*360/Z+e[2j+1].

Next, max (e[2j]), which is the maximum value of the cumulative pitch error e[2j] of the left tooth surface calculated as described above, and min (e[2j+1]), which is the minimum value of the cumulative pitch error e[2j+1] of the right tooth surface, are calculated (the cumulative pitch error having the maximum absolute value).

Then, the phase of teeth of the workpiece gear is calculated using the following formula:

Phase of teeth[deg]=(C[0]+C[1])/2+(max(e[2j])+min(e[2j+1])/2

where (C[0]+C[1])/2 represents an angle of a center of a first tooth with respect to a reference direction.

However, the phase of the teeth [deg] calculated as described above is calculated on the basis of the angle of the left tooth surface of the tooth number 1, the angle of the right tooth surface of the tooth number 1, the left tooth surface maximum cumulative pitch error for the tooth at which the cumulative pitch error of the left tooth surface is maximum, and the right tooth surface minimum cumulative pitch error for the tooth at which the cumulative pitch error of the right tooth surface is minimum. Specifically, irrespective of the number of teeth, the phase of the teeth is calculated on the basis of the angles of four tooth surfaces.

In contrast, in recent years, with a demand for a reduction in noise of automobile gears and the like, gear machining with a higher degree of accuracy is desired, and in line with this, improvement is also required in a calculation accuracy of the phase of teeth of a gear.

In light of the foregoing, an object of the present invention is to further improve a calculation accuracy of the phase of teeth of a gear.

### Solution to Problem

A method of the present invention is a method for calculating a phase of teeth of a gear, the gear having Z number of teeth. The method includes the steps of:

a gear teeth amplitude signal acquiring step of acquiring a gear teeth amplitude signal S(c) corresponding to at least one revolution of the gear, the gear teeth amplitude signal S(c) being formed by an association of an angle c of the gear and a value corresponding to irregularities on an outer circumference of the gear within the angle c; a phase calculating step of calculating a phase B of an angular pitch P of the gear in accordance with the number of teeth Z when the gear teeth amplitude signal S(c) is subjected to frequency decomposition; and a gear meshing angle calculating step of calculating a gear meshing angle on the basis of the phase B calculated in the phase calculating step.

According to the present invention having this type of configuration, the gear teeth amplitude signal S(c) is subjected to frequency analysis, and the phase corresponding to the angular pitch in accordance with the number of teeth Z for the gear teeth amplitude signal subjected to the frequency analysis is calculated. As a result, the phase is calculated substantially on the basis of the angles of all the front tooth surfaces and the rear tooth surfaces, allowing the phase calculation to be performed with a higher degree of accuracy.

In the present invention, it is preferable that in the phase calculating step, the phase B of the angular pitch P of the gear in accordance with the number of teeth Z be calculated by approximating to zero a difference between a cumulative pitch error of a front tooth surface of each of the teeth and an average value of the cumulative pitch errors of the front tooth surfaces of all the teeth and a difference between a cumulative pitch error of a rear tooth surface of each of the teeth and an average value of the cumulative pitch errors of the rear tooth surfaces of all the teeth. The cumulative pitch error is a difference between a theoretical angle position of the front tooth surface of each of the teeth and an angle position of the front tooth surface of each of the teeth or a difference between a theoretical angle position of the rear tooth surface of each of the teeth and an angle position of the rear tooth surface of each of the teeth, the theoretical angle position is determined taking a front tooth surface or a rear tooth surface of a predetermined tooth as reference, and the angle position is determined on the basis of the gear teeth amplitude signal.

Further, in the present invention, it is preferable that in the phase calculating step, the phase B be calculated on the basis of angle positions of front and rear surfaces of a predetermined tooth and an average value of cumulative pitch errors of the front and rear surfaces of all the teeth.

Further, in the present embodiment, it is preferable that in the gear teeth amplitude signal acquiring step, the gear teeth amplitude signal S(c) be acquired such that the angle c is a predetermined value when the angle c corresponds to a position between both tooth surfaces of a tooth of the gear and the angle c is zero when the angle c corresponds to a position between adjacent teeth of the gear, and in the phase calculating step, the phase B be calculated on the basis of the following formulas:

$$C [ 2 j ] = C [ 0 ] + j * 360 / Z + e [ 2 j ] \\ C [ 2 j + 1 ] = C [ 1 ] + j * 360 / Z + e [ 2 j + 1 ] \\ Ea [ 1 ] = \frac{1}{Z} {\sum }_{j = 0}^{Z - 1} ( e [ 2 j + 1 ] ) \\ Ea [ 0 ] = \frac{1}{Z} {\sum }_{j = 0}^{Z - 1} ( e [ 2 j ] ) \\ B \approx ( C [ 0 ] + C [ 1 ] + Ea [ 0 ] + Ea [ 1 ] ) / 2. \qquad [ Formulas 1 ]$$

According to the present invention having this type of configuration, by performing the approximation, the number of calculations necessary to calculate the phase can be reduced, and the phase can be calculated more restrictively.

Further, in the present invention, it is preferable that in the phase calculating step, the phase B of the angular pitch P of the gear in accordance with the number of teeth Z be obtained by performing Fourier transform on the gear teeth amplitude signal S(c).

Further, in the present invention, it is preferable that in the phase calculating step, the phase B be calculated on the basis of the following formulas:

$$B = \frac{360}{2 π Z} * a tan ( \frac{b ( Z )}{a ( z )} ) \\ a ( Z ) = \frac{2}{360} {\int }_{0}^{360} S ( c ) cos ( \frac{2 π Zc}{360} ) d c \\ b ( Z ) = \frac{2}{360} {\int }_{0}^{360} S ( c ) sin ( \frac{2 π Zc}{360} ) d c \qquad [ Formulas 2 ]$$

where B represents the phase, and Z represents the number of teeth of the gear.

According to the present invention having this type of configuration, by using Fourier analysis, the calculation accuracy of the phase can be further improved.

A gear teeth phase calculation device of the present invention is a device for calculating a phase of teeth of a gear, the gear having Z number of teeth. The gear teeth phase calculation device includes: gear teeth amplitude signal acquiring means for acquiring a gear teeth amplitude signal S(c) corresponding to at least one revolution of the gear, the gear teeth amplitude signal S(c) being formed by an association of an angle c of the gear and a value corresponding to irregularities on an outer circumference of the gear within the angle c; phase calculating means for calculating a phase of an angular pitch P of the gear in accordance with the number of teeth Z when the gear teeth amplitude signal S(c) is subjected to frequency decomposition; and gear meshing angle calculating means for calculating a gear meshing angle on the basis of the phase calculated by the phase calculating means by a phase calculation unit.

Further, a gear machining apparatus of the present invention includes: the above-described gear teeth phase calculation device; and a machining device configured to adjust a position of the gear on the basis of a phase of teeth of the gear detected by the gear teeth phase calculation device, and to machine the gear.

### Advantageous Effects of Invention

The present invention can further improve the calculation accuracy of the phase of teeth of a gear.

### BRIEF DESCRIPTION OF DRAWINGS

FIG. 1 is a perspective view illustrating portions that machine a gear, of a gear machining apparatus according to a first embodiment.

FIG. 2 is a schematic diagram illustrating a configuration of a phase calculation device in the gear machining apparatus in FIG. 1.

FIGS. 3A and 3B are diagrams illustrating a method for converting a sensor amplitude signal to a pulse signal.

FIG. 4 is a diagram illustrating a relationship between an angle signal input to a measuring unit and an ON-OFF signal.

FIGS. 5A and 5B are diagrams illustrating a gear teeth amplitude signal S(c) and a relationship between the gear teeth amplitude signal S(c) and a tooth surface of a workpiece gear, where FIG. 5A illustrates the workpiece gear and FIG. 5B illustrates the gear teeth amplitude signal S(c).

FIG. 6 is a graph showing a cumulative pitch error measured on a workpiece gear having 31 teeth.

FIG. 7 is a graph showing a cumulative pitch error measured on a workpiece gear having 208 teeth.

FIG. 8 is data of a simulated cumulative pitch error.

### DESCRIPTION OF EMBODIMENTS

A first embodiment of a gear machining apparatus of the present invention will be described in detail below with reference to the drawings.

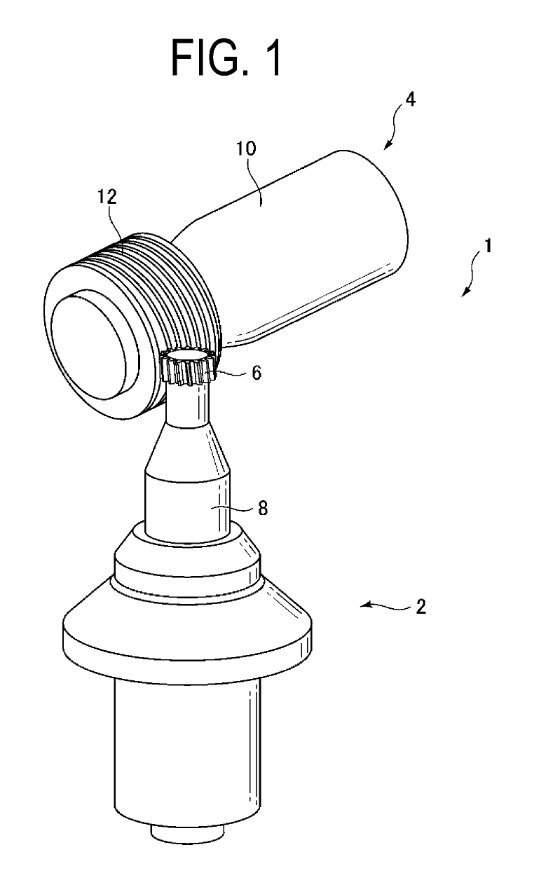

FIG. 1 is a perspective view illustrating portions that machine a gear, of the gear machining apparatus according to the first embodiment. As illustrated in FIG. 1, a gear machining apparatus 1 of the first embodiment is a device for finishing a workpiece gear 6 that has been gear cut by a gear cutting machine, such as a bobbing machine. The gear machining apparatus 1 is provided with a gear support mechanism 2 supporting the workpiece gear 6, and a gear teeth grinding mechanism 4 that grinds the workpiece gear 6.

The gear support mechanism 2 is provided with a rotating shaft 8 that can be rotatably driven by a rotational drive device (not illustrated). The workpiece gear 6 that has been gear cut by the gear cutting machine is fixed to a leading end of the rotating shaft 8. In order to adjust a position of the workpiece gear 6 with respect to the gear teeth grinding mechanism 4, the gear support mechanism 2 can move in any direction, frontward and rearward, upward and downward, and leftward and rightward.

The gear teeth grinding mechanism 4 is provided with a rotating shaft 10 that can be rotated by a rotational drive device (not illustrated), and with a grinding member 12 attached to a leading end of the rotating shaft 10. For example, a threaded grindstone can be used as the grinding member 12. The rotating shaft 10 of the gear teeth grinding mechanism 4 is provided so as to be orthogonal to the rotating shaft 8 of the gear support mechanism 2.

The gear machining apparatus 1 of the present embodiment first detects a phase of the workpiece gear 6, using a phase calculation device that will be described later. On the basis of the detected phase, the gear machining apparatus 1 performs gear meshing (angle adjustment) between the teeth of the workpiece gear 6 and the teeth of the grinding member 12. Then, in a state in which the grinding teeth of the grinding member 12 of the gear teeth grinding mechanism 4 and the teeth of the workpiece gear 6 are meshed with each other, the rotational drive devices of the gear support mechanism 2 and the gear teeth grinding mechanism 4 are caused to rotate while being synchronized with each other, finishing of the workpiece gear.

Hereinafter, a detailed description will be given of a configuration of the phase calculation device of the gear machining apparatus of the present embodiment.

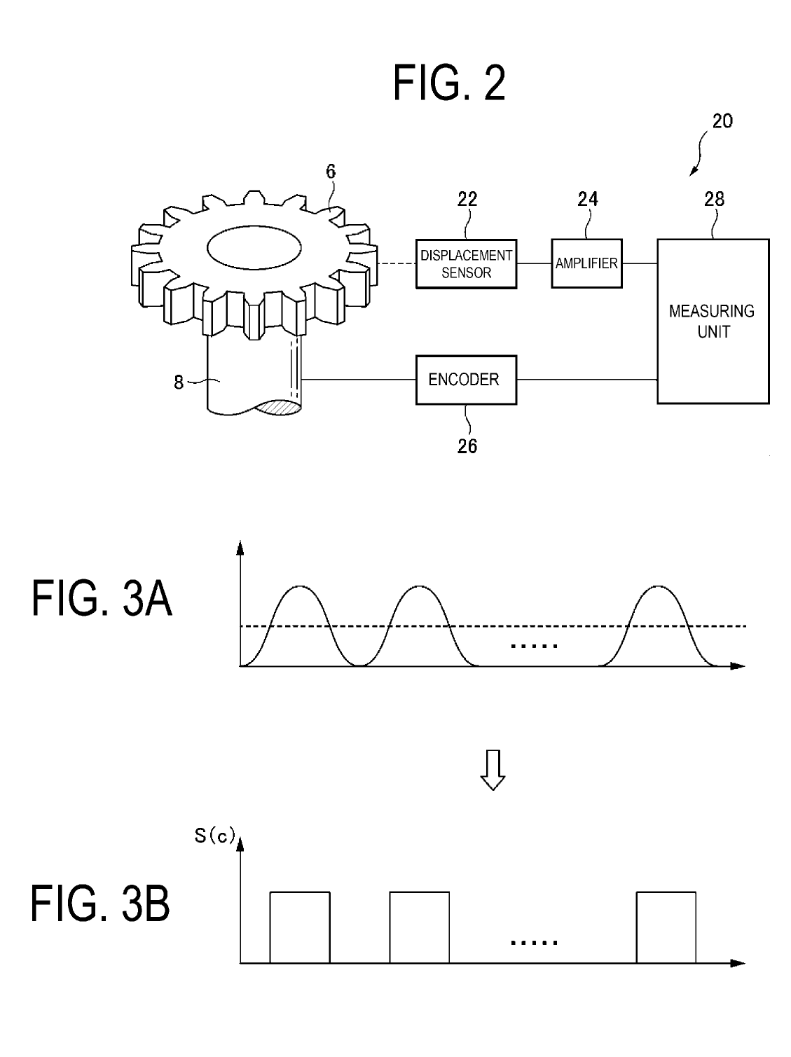

FIG. 2 is a schematic diagram illustrating the configuration of a phase calculation device 20 of the gear machining apparatus in FIG. 1. As illustrated in FIG. 2, the phase calculation device 20 is provided with a displacement sensor 22, an amplifier 24 connected to the displacement sensor 22, an encoder 26, and a measuring unit 28 connected to the amplifier 24 and the encoder 26.

The encoder 26, which is, for example, an incremental rotary encoder, is attached to the rotating shaft 8 of the gear support mechanism 2. The encoder 26 outputs Z phase, A phase, and B phase pulse signals when the rotating shaft 8 of the gear support mechanism 2 is rotated. A single pulse of the Z phase pulse signal is output each time the rotating shaft 8 rotates by 360 degrees. The A phase and the B phase pulse signals are phase-shifted from each other by 90 degrees, and a predetermined number of pulses are output for each of the signals when the rotating shaft 8 is rotated by 360 degrees. The Z phase, A phase, and B phase pulse signals (hereinafter referred to as angle signals) are input to the measuring unit 28.

An optical distance measuring device and the like can be used as the displacement sensor 22, for example, and a measurement direction is directed toward a center of the workpiece gear 6. The displacement sensor 22 measures a distance from the displacement sensor 22 to a tooth surface of the workpiece gear 6, and outputs a signal corresponding to this distance (namely, a signal corresponding to the irregularities on the outer circumference of the workpiece gear, and hereinafter referred to as a sensor amplitude signal). The sensor amplitude signal output in this way is input to the amplifier 24.

In the amplifier 24, the input sensor amplitude signal is converted to a pulse signal. FIG. 3 is a diagram illustrating a method for converting the sensor amplitude signal to the pulse signal. In the amplifier 24, a threshold value is set in advance, and, when a gear teeth amplitude signal exceeds this threshold value, a signal having a value of 1 is output, and when the gear teeth amplitude signal is equal to or less than this threshold value, a signal having a value of 0 is output. Thus, the gear teeth amplitude signal output from the displacement sensor 22 illustrated in FIG. 3A is converted to the pulse signal (hereinafter referred to as an ON-OFF signal) illustrated in FIG. 3B.

The measuring unit 28 A/D converts the angle signal and the ON-OFF signal to a digital angle signal and a digital ON-OFF signal, respectively. On the basis of the digital angle signal and the digital ON-OFF signal, the measuring unit 28 generates a digital gear teeth amplitude signal S(c) for angles from 0 to 360 degrees, where an angle position at which the Z phase pulse is output is a reference (0 degrees). Then, the digital gear teeth amplitude signal S(c) is subjected to Fourier transform, and the phase of components of a pitch P=360/Z of the digital gear teeth amplitude signal S(c) subjected to the Fourier transform is determined. On the basis of this phase, a gear meshing angle is calculated.

Below, principles of the calculation of the gear meshing angle by the measuring unit 28 will be described. The following description is of a case in which the gear teeth amplitude signal S(c) is an analog signal (a continuous function), but the calculation can be applied to a digital signal (a discrete function). Further, the following description is of a case in which the gear teeth amplitude signal S(c) is used, which is a signal generated by converting the sensor amplitude signal for the angles of 0 to 360 degrees to the ON-OFF signal formed by the two values (1 or 0), where the angle position at which the Z phase pulse is output is the reference (0 degrees). However, the present invention is not limited to this example, and the sensor amplitude signal for the angles of 0 to 360 degrees, where the angle position at which the Z phase pulse is output is the reference (0 degrees) can be used as the gear teeth amplitude signal S(c).

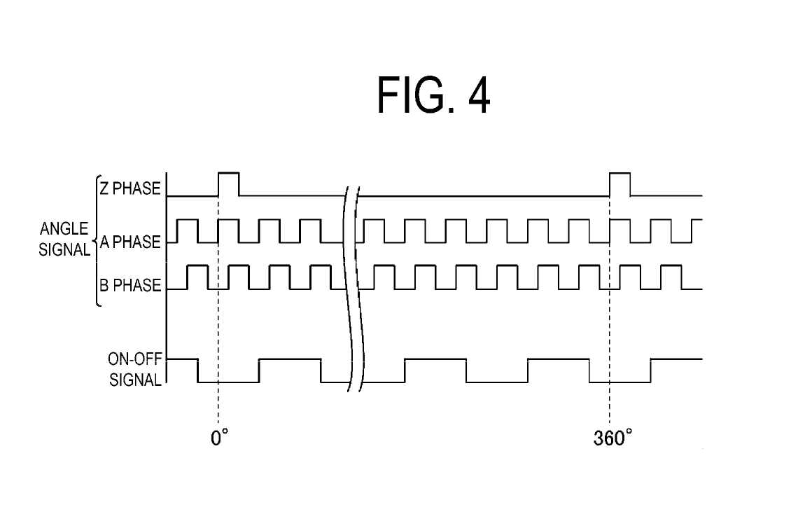

FIG. 4 is a diagram illustrating a relationship between the angle signal input to the measuring unit 28 and the ON-OFF signal. A time point at which the Z phase pulse appears is taken as the reference angle, namely 0 degrees, and a time point at which the Z phase pulse appears once more is taken as 360 degrees. Next, on the basis of the numbers of the A phase and the B phase pulses, angles at each of the time points in relation to the reference angle are calculated. Then, by associating the angles in relation to the reference angle calculated in the above-described manner with the ON-OFF signal, the gear teeth amplitude signal S(c) is generated within an angle range of 0 to 360 degrees.

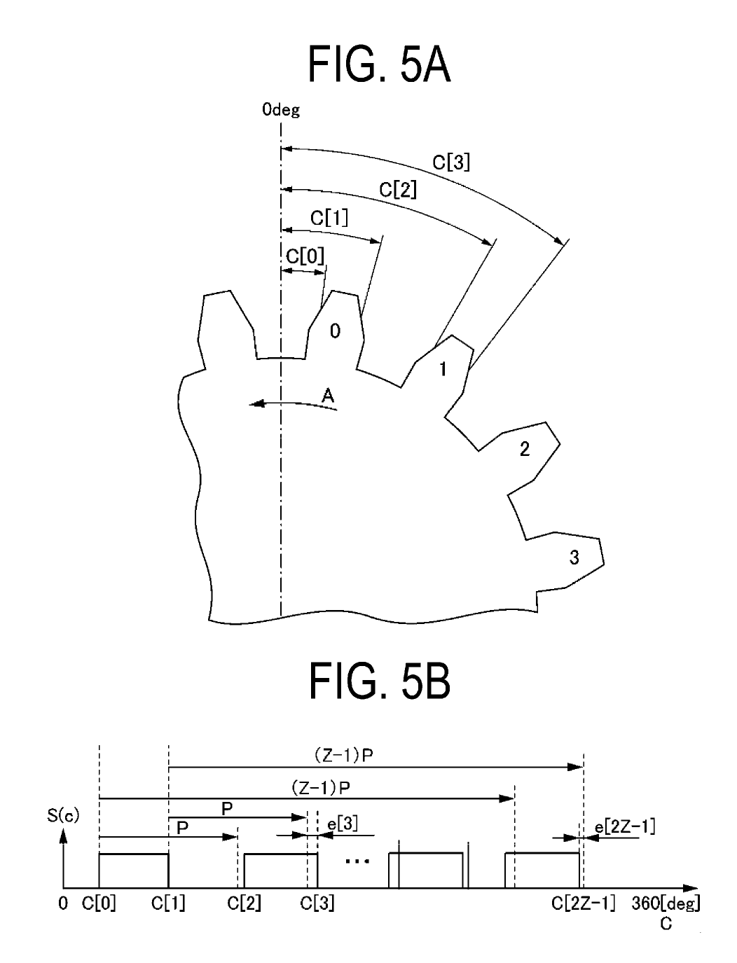

FIGS. 5A and 5B are diagrams illustrating the gear teeth amplitude signal S(c) generated in this manner, and a relationship between the gear teeth amplitude signal S(c) and the tooth surface of the workpiece gear 6. FIG. 5A illustrates the workpiece gear 6 and FIG. 5B illustrates the gear teeth amplitude signal S(c). As illustrated in FIG. 5, an angle C(1) corresponding to the rising edge of a first pulse of the gear teeth amplitude signal S(c) is an angle from the reference angle of the workpiece gear 6 to an angle at which a tooth surface (the left tooth surface) on a front side in a reverse direction (hereinafter referred to as a measurement direction) to a workpiece gear rotation direction A of a first tooth (assumed to be a tooth 0) in the measurement direction is located. Further, the angle C(1) at which the first pulse of the gear teeth amplitude signal S(c) becomes zero corresponds to an angle from the reference angle of the workpiece gear 6 to an angle at which a tooth surface (the right tooth surface) on a rear side in the measurement direction of the first tooth (the tooth 0) in the measurement direction is located. Below, in a similar manner, assuming that the tooth numbers of each of the teeth in the measurement direction from the reference angle are 0 to Z−1, an angle at which a front side tooth surface of the tooth having the tooth number j is located is C[2j], and an angle at which a rear side tooth surface is located is C[2j+1].

Further, when the workpiece gear 6 has been machined without any error, an angle between adjacent front tooth surfaces (or between adjacent rear tooth surfaces) is 360/Z [deg]. Then, assuming that the workpiece gear 6 has been machined without error, with respect to each of the tooth surfaces, if C[0] and C[1] are taken as reference, theoretical angle positions C′[k] of the front and rear tooth surfaces are C′[2j]=C[0]+j*360/Z, and C′[2j+1]=C[1]+j*360/Z, respectively. If a difference between the theoretical tooth surface angle position C′[k], and an actual tooth surface angle position (hereinafter referred to as a cumulative pitch error) is e[k] (k=0 to 2z−1), the following formulas are obtained. Note that e[0] and e[1] are set to zero.

$$S ( c ) = \{ \begin{matrix}1 & C ⌈ 2 j ⌉ \leq C \leq C ⌈ 2 j + 1 ⌉ \\ 0 & other than the above\end{matrix} \\ C [ 2 j ] = C [ 0 ] + j * 360 / Z + e [ 2 j ] \\ C [ 2 j + 1 ] = C [ 1 ] + j * 360 / Z + e [ 2 j + 1 ] \qquad [ Formulas 3 ]$$

where j represents the tooth number (j=0 to Z−1), c represents an angle of tooth to be measured (deg), C[k] represents a tooth surface angle (deg), and e[k] represents a cumulative pitch error (deg).

The gear teeth amplitude signal S(c) is a pitch function of a 360 degree pitch, irrespective of the workpiece gear. Here, when the gear teeth amplitude signal S(c) is subjected to Fourier expansion, it is expressed as below.

$$S ( c ) = {\sum }_{n = 0}^{∞} ( a ( n ) cos \frac{2 π nc}{360} + b ( n ) sin \frac{2 π nc}{360} ) \\ a ( n ) = \frac{2}{360} {\int }_{0}^{360} S ( c ) cos ( \frac{2 n πc}{360} ) d c \\ b ( n ) = \frac{2}{360} {\int }_{0}^{360} S ( c ) sin ( \frac{2 n πc}{360} ) d c \qquad [ Formulas 4 ]$$

Here, a component of a workpiece gear angular pitch (the pitch) P=360/Z is a term of n=Z (the tooth number), and a phase of that component is a phase of the teeth of the workpiece gear. If A represents the amplitude of the component of the pitch P=360/Z, and B represents the phase, the following formula is obtained:

$$Pitch P component = a ( Z ) cos ( \frac{2 π Zc}{360} ) + b ( Z ) sin ( \frac{2 π Zc}{360} ) ≡ A cos ( \frac{2 π Z ( c - B )}{360} ) . \qquad [ Formula 5 ]$$

Further, the above Formula 5 can be transformed as below:

$$A cos ( \frac{2 π Z ( c - B )}{360} ) = A sin ( \frac{2 π B}{360} ) sin ( \frac{2 π Zc}{360} ) + A cos ( \frac{2 π ZB}{360} ) cos ( \frac{2 π Zc}{360} ) . \qquad [ Formula 6 ]$$

Thus, the phase B [deg] of teeth can be calculated using the formulas below:

$$B = \frac{360}{2 πZ} * a tan ( \frac{b ( Z )}{a ( Z )} ) \\ a ( Z ) = A cos ( \frac{2 π ZB}{360} ) = \frac{2}{360} {\int }_{0}^{360} S ( c ) cos ( \frac{2 π Zc}{360} ) d c \\ b ( Z ) = A sin ( \frac{2 π ZB}{360} ) = \frac{2}{360} {\int }_{0}^{360} S ( c ) sin ( \frac{2 π Zc}{360} ) d c \qquad [ Formulas 7 ]$$

where when the phase B [deg] of teeth is 0 degrees, the reference angle at which the phase Z pulse is output from the encoder is aligned with an angle of a center of the teeth of the workpiece gear.

In this way, the gear teeth amplitude signal S(c) is subjected to Fourier transform, and the phase of the component of the pitch P=360/Z of the Fourier transformed gear teeth amplitude signal is calculated. On the basis of this phase, a gear meshing angle can be calculated such that the bottom lands of the troughs of the workpiece gear are aligned with the top lands of the crests of the grinding member 12 of the gear teeth grinding mechanism 4.

Below, a method for finishing the workpiece gear 6 using the gear machining apparatus of the first embodiment will be described. In the phase calculation device 20, the number of teeth Z of the workpiece gear 6 is set in advance.

First, the workpiece gear 6 is attached to the leading end of the rotating shaft 8 of the gear support mechanism 2. Then, the workpiece gear 6 is rotated by the gear support mechanism 2.

When the workpiece gear 6 is rotated by the gear support mechanism 2, the encoder 26 generates the angle signal, and the angle signal is input to the measuring unit 28. Further, in parallel to this, the displacement sensor 22 outputs the gear teeth amplitude signal corresponding to the distance to the outer circumference of the workpiece gear 6. Note that, with respect to the Z phase pulse signal of the angle signal, the gear support mechanism 2 rotates the workpiece gear 6 by an angle equal to or greater than an angle including at least two of the pulses.

The gear teeth amplitude signal output from the displacement sensor 22 is input to the amplifier 24. The amplifier 24 outputs the ON-OFF signal, which has a value of 1 when the gear teeth amplitude signal is equal to or greater than the preset threshold value, and which has a value of 0 when the gear teeth amplitude signal is equal to or less than the threshold value. The amplitude pulse signal output from the amplifier 24 is input to the measuring unit 28.

The measuring unit 28 A/D converts the angle signal and the ON-OFF signal to the digital angle signal and the digital ON-OFF signal, respectively. Then, as described in reference to FIG. 4, on the basis of the digital angle signal and the digital ON-OFF signal, the measuring unit 28 generates the digital gear teeth amplitude signal S(c) of the angles from 0 to 360 degrees, where the angle position at which the Z phase pulse is output is the reference (0 degrees) (a gear teeth amplitude signal acquiring step).

Next, the measuring unit 28 performs Fast Fourier Transform (FFT) on the digital gear teeth amplitude signal S(c). Then, the measuring unit 28 acquires the phase of the component of the pitch P=360/Z of the digital gear teeth amplitude signal S(c) subjected to FFT (a phase calculating step). Then, on the basis of this phase, the gear meshing angle is calculated such that the crests of the workpiece gear match the troughs of the grinding member 12 (a gear meshing angle calculating step).

Then, the gear support mechanism 2 rotates the workpiece gear 6 by the calculated gear meshing angle, and in this state, the grinding member 12 of the gear teeth grinding mechanism 4 is moved toward the workpiece gear 6. Then, in this state, the workpiece gear 6 is finished by the grinding member 12 that is being rotated by the rotational drive device of the gear teeth grinding mechanism 4 in synchronization with the workpiece gear 6 that is being rotated by the rotational drive device of the gear support mechanism 2.

As described above, according to the present embodiment, the gear teeth amplitude signal S(c) is subjected to frequency analysis by Fourier transform, and the phase corresponding to the angular pitch with respect to the Fourier transformed gear teeth amplitude signal in accordance with the number of teeth Z is calculated. Thus, the phase is substantially calculated on the basis of the angles of all the front teeth surfaces and all the rear teeth surfaces, allowing the phase calculation to be performed with a higher degree of accuracy.

Here, in the above-described method of the first embodiment, the phase of the workpiece gear is calculated using Fourier expansion (FFT), and the gear meshing angle is calculated on the basis of the calculation result. Thus, a computational load in the measuring unit 28 is high, and the gear meshing takes time.

Thus, the applicant has proposed a method for calculating the gear meshing angle with a high degree of accuracy and a low computational load. Note that, in the present embodiment, a signal generated by converting the sensor amplitude signal for the angles of 0 to 360 degrees to the ON-OFF signal formed by the two values (1 or 0), where the angle position at which the Z phase pulse is output is the reference (0 degrees), is used as the gear teeth amplitude signal S(c).

First, principles of a method for calculating the phase of the workpiece gear according to a second embodiment will be described.

As described above, the gear teeth amplitude signal S(c) indicates 1 within a range of C[2j]≦C≦C[2j+1], and indicates 0 in other cases. Thus, a(n), b(n) in the above-described Formulas 7 can be re-written as below:

$$a ( z ) \begin{matrix}= ( \frac{2}{360} ) {\sum }_{j = 0}^{Z - 1} ( {\int }_{C [ 2 j ]}^{C ⌈ 2 j \vert 1 ⌉} cos ( \frac{2 π Zc}{360} ) d c ) \\ = \frac{1}{π Z} {\sum }_{j = 0}^{Z - 1} ( sin ( \frac{2 π ZC ⌊ 2 j + 1 ⌋}{360} ) - sin ( \frac{2 π ZC ⌊ 2 j ⌋}{360} ) )\end{matrix} \\ \begin{matrix}b ( z ) = ( \frac{2}{360} ) {\sum }_{j = 0}^{Z - 1} ( {\int }_{C [ 2 j ]}^{C [ 2 j + 1 ]} sin ( \frac{2 π Zc}{360} ) d c ) \\ = \frac{1}{π Z} {\sum }_{j - 0}^{Z - 1} ( - cos ( \frac{2 π ZC ⌊ 2 j + 1 ⌋}{360} ) + cos ( \frac{2 π ZC ⌊ 2 j ⌋}{360} ) ) .\end{matrix} \qquad [ Formulas 8 ]$$

If Formulas 8 are developed, the following formulas are obtained:

$$π Za ( Z ) = 2 {\sum }_{j = 0}^{Z - 1} ( cos ( \frac{π Z ( C [ 2 j + 1 ] + C [ 2 j ] )}{360} ) sin ( \frac{π Z ( C [ 2 j + 1 ] - C [ 2 j ] )}{360} ) ) \\ π Zb ( Z ) = 2 {\sum }_{j = 0}^{Z - 1} ( sin ( \frac{π Z ( C [ 2 j + 1 ] + C [ 2 j ] )}{360} ) sin ( \frac{π Z ( C [ 2 j + 1 ] - C [ 2 j ] )}{360} ) ) . \qquad [ Formulas 9 ]$$

Here, an average of the cumulative pitch errors of the front tooth surfaces in the rotational direction of all the teeth is Ea[0], and an average of the cumulative pitch errors of the rear tooth surfaces in the rotational direction of all the teeth is Ea[1]. Ea[0] and Ea[1] are expressed as below:

$$Ea [ 1 ] = \frac{1}{Z} {\sum }_{j = 0}^{Z - 1} ( e [ 2 j + 1 ] ) \\ Ea [ 0 ] = \frac{1}{Z} {\sum }_{j = 0}^{Z - 1} ( e ⌈ 2 j ⌉ ) . \qquad [ Formulas 10 ]$$

Then, a difference between the cumulative pitch error of each of the tooth surfaces and the average of the cumulative pitch errors is expressed as below:

δ[2j]=e[2j]−Ea[0]

δ[2j+1]=e[2j+1]−Ea[1].

Thus, the above Formulas 8 can be re-written as follows:

$$π Za ( Z ) = 2 {\sum }_{j = 0}^{Z - 1} ( cos ( \frac{\begin{matrix}π Z ( C [ 0 ] + C [ 1 ] + Ea [ 0 ] + \\ Ea [ 1 ] + δ [ 2 j ] + δ [ 2 j + 1 ] )\end{matrix}}{360} ) sin ( \frac{π Z ( C [ 2 j + 1 ] - C [ 2 j ] )}{360} ) ) \\ π Zb ( Z ) = 2 {\sum }_{j - 0}^{Z - 1} ( sin ( \frac{\begin{matrix}π Z ( C [ 0 ] + C [ 1 ] + Ea [ 0 ] + \\ Ea [ 1 ] + δ [ 2 j ] + δ [ 2 j + 1 ] )\end{matrix}}{360} ) sin ( \frac{π Z ( C [ 2 j + 1 ] - C [ 2 j ] )}{360} ) ) \qquad [ Formulas 11 ]$$

Here, since |C[0]+C[1]+Ea[0]+Ea[1] |>>|δ[2j+1]+6[2j]| is satisfied, if δ[2j]≈0 and δ[2j+1]≈0 are satisfied, the above formulas can be re-written as follows:

$$π Za ( Z ) \approx 2 cos ( \frac{π Z ( C [ 0 ] + C [ 1 ] + Ea [ 0 ] + Ea [ 1 ] )}{360} ) {\sum }_{j - 0}^{Z - 1} sin ( \frac{π Z ( C [ 2 j + 1 ] - C ⌈ 2 j ⌉ )}{360} ) \\ π Zb ( Z ) \approx 2 sin ( \frac{π Z ( C [ 0 ] + C [ 1 ] + Ea [ 0 ] + Ea [ 1 ] )}{360} ) {\sum }_{j = 0}^{Z - 1} sin ( \frac{π Z ( C [ 2 j + 1 ] - C [ 2 j ] )}{360} ) . \qquad [ Formulas 12 ]$$

Thus, the B phase [deg] of the teeth can be calculated using the following formulas:

$$\begin{matrix} B = \frac{360}{2 π Z} * a tan ( \frac{b ( z )}{a ( z )} ) & [ Formulas 13 ] \\ \frac{b ( z )}{a ( z )} \approx \frac{sin ( \frac{π Z ( C [ 0 ] + C [ 1 ] + Ea [ 0 ] + Ea [ 1 ] )}{360} )}{cos ( \frac{π Z ( C [ 0 ] + C [ 1 ] + Ea [ 0 ] + Ea [ 1 ] )}{360} )} \approx tan ( \frac{π Z ( C ⌊ 0 ⌋ + C ⌊ 1 ⌋ + Ea ⌊ 0 ⌋ + Ea ⌊ 1 ⌋ )}{360} ) . & \end{matrix}$$

If this is solved, the following is obtained:

$$\frac{2 π ZB}{360} \approx ( \frac{π Z ( C ⌊ 0 ⌋ + C ⌊ 1 ⌋ + Ea ⌊ 0 ⌋ + Ea ⌊ 1 ⌋ )}{360} ) . \qquad [ Formulas 14 ]$$

As a result, if Ea[0] and Ea[1] are calculated as below, the B phase can be approximated by B (C[0]+C[1]+Ea[0]+Ea[1])/2, on the basis of the angle positions C[0] and C[1] of the front and rear tooth surfaces of the tooth number 1, and the averages Ea[0] and Ea[1] of the cumulative pitch errors of the front tooth surfaces and the rear tooth surfaces of all the teeth:

$$Ea ⌈ 1 ⌉ = \frac{1}{Z} {\sum }_{j = 0}^{Z - 1} ( e \vert 2 j + 1 \vert ) \\ Ea [ 0 ] = \frac{1}{Z} {\sum }_{j = 0}^{Z - 1} ( e [ 2 j ] ) . \qquad [ Formulas 15 ]$$

In the second embodiment as described above, when calculating the frequency component of the workpiece gear pitch (the pitch) P=360/Z of the gear teeth amplitude signal S(c), the difference between the cumulative pitch error of each of the tooth surfaces and the average cumulative pitch error is approximated to zero, and the phase is calculated. In this way, the calculation of the frequency components of the workpiece gear pitch (the pitch) P=360/Z becomes easier.

Below, a method for finishing the workpiece gear 6 using a gear machining apparatus of the second embodiment will be described. The configuration of the gear machining apparatus of the second embodiment is the same as that of the first embodiment except in that the method for calculating the phase using the measuring unit 28 differs.

In the phase calculation device 20, the number of teeth Z of the workpiece gear 6 is set in advance.

First, the workpiece gear 6 is attached to the leading end of the rotating shaft 8 of the gear support mechanism 2. Then, the workpiece gear 6 is rotated by the gear support mechanism 2.

When the workpiece gear 6 is rotated by the gear support mechanism 2, the encoder 26 generates the angle signal, and the angle signal is input to the measuring unit 28. Further, in parallel to this, the displacement sensor 22 outputs the gear teeth amplitude signal corresponding to the distance to the outer circumference of the workpiece gear 6. Note that, with respect to the Z phase pulse signal of the angle signal, the gear support mechanism 2 rotates the workpiece gear 6 by the angle equal to or greater than the angle including at least two of the pulses.

The gear teeth amplitude signal output from the displacement sensor 22 is input to the amplifier 24. The amplifier 24 outputs the ON-OFF signal, which has a predetermined value when the gear teeth amplitude signal is equal to or greater than the preset threshold value, and which has a value of 0 when the gear teeth amplitude signal is equal to or less than the threshold value. The amplitude pulse signal output from the amplifier 24 is input to the measuring unit 28.

The measuring unit 28 A/D converts the angle signal and the ON-OFF signal to the digital angle signal and the digital ON-OFF signal, respectively. As described with reference to FIG. 3, on the basis of the digital angle signal and the digital ON-OFF signal, the measuring unit 28 generates the digital gear teeth amplitude signal S(c) for the angles from 0 to 360 degrees, where the angle position at which the phase Z pulse is output is the reference (0 degrees) (the gear teeth amplitude acquiring step).

Next, the measuring unit 28 calculates the cumulative pitch error on the basis of the digital gear teeth amplitude signal S(c). The cumulative pitch error can be calculated on the basis of the following formulas:

C[2j]=C[0]+j*360/Z+e[2j]

C[2j+1]=C[1]+j*360/Z+e[2j+1].

Next, where the average cumulative pitch error of the front tooth surfaces in the rotation direction is Ea[1], the measuring unit 28 calculates the average cumulative pitch error Ea[0] of the rear tooth surfaces in the rotation direction on the basis of the following formulas:

$$Ea [ 1 ] = \frac{1}{Z} {\sum }_{j = 0}^{Z - 1} ( e \vert 2 j + 1 \vert ) \\ Ea [ 0 ] = \frac{1}{Z} {\sum }_{j = 0}^{Z - 1} ( e [ 2 j ] ) . \qquad [ Formulas 16 ]$$

Next, the measuring unit 28 performs approximation using B≈C[0]+C[1]+Ea[0]+Ea[1])/2, and calculates the phase B (the phase calculating step). Then, on the basis of this phase, the gear meshing angle is calculated such that the crests of the workpiece gear match the troughs of the grinding member 12 (the gear meshing angle calculating step).

Then, the gear support mechanism 2 rotates the workpiece gear 6 by the calculated gear meshing angle, and in this state, the grinding member 12 of the gear teeth grinding mechanism 4 is moved toward the workpiece gear 6. Then, in this state, the workpiece gear 6 is finished by the grinding member 12 that is being rotated by the rotational drive device of the gear teeth grinding mechanism 4 in synchronization with the workpiece gear 6 that is being rotated by the rotational drive device of the gear support mechanism 2.

According to the present embodiment, by approximating the difference 6 between the cumulative pitch error of each of the tooth surfaces and the average cumulative pitch error to zero and calculating the phase of the angular pitch P of the gear in accordance with the number of teeth Z, the number of calculations for calculating the phase can be reduced, and the time required for the phase calculation can be reduced.

It should be noted that, in each of the above-described embodiments, a description is given of a case in which the phase calculation device is applied to the machining device for the finishing of the gear, but the present invention is not limited to this example, and the phase calculation device of the present invention can be applied to any device requiring gear meshing of a gear.

Here, the inventor et al. has made a comparative examination of the calculation accuracy of the phase calculation method of the first and second embodiments with a conventional calculation method (the method disclosed in Patent Document 1), as described below.

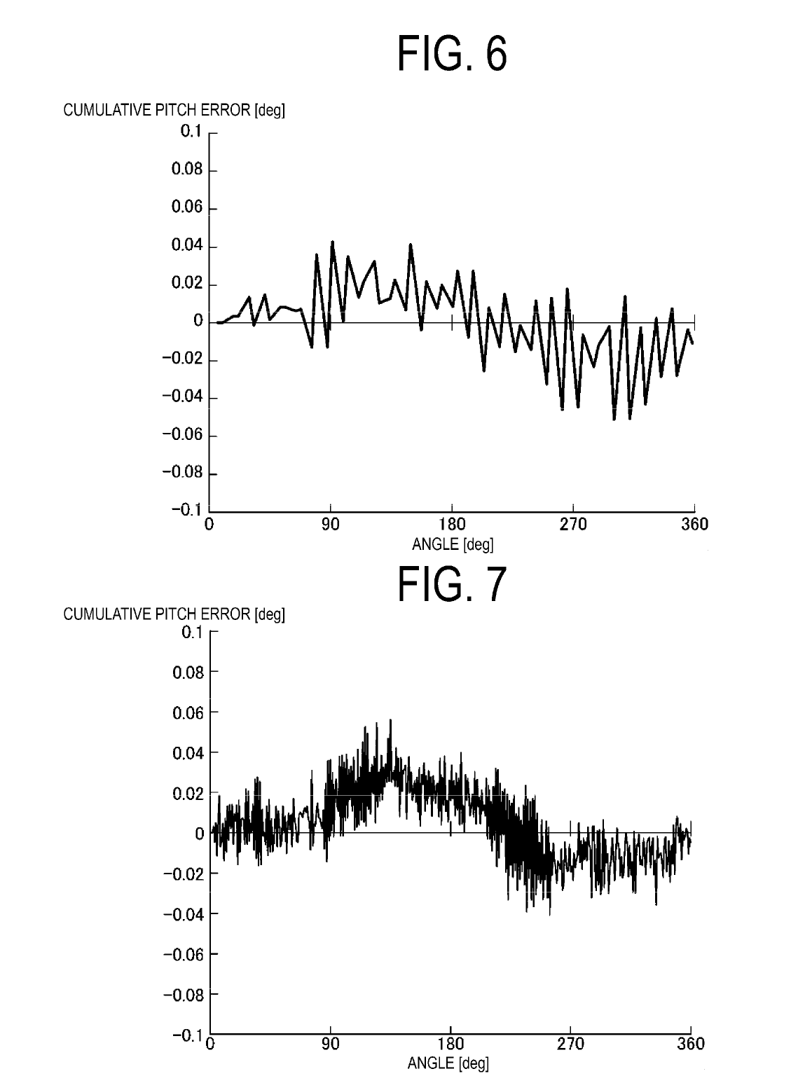

In the present examination, first, the phase was calculated for workpiece gears having 31 teeth and having 208 teeth, using the method of the first embodiment (hereinafter referred to as a “Working Example 1”), using the method of the second embodiment (hereinafter referred to as a “Working Example 2”), and the conventional calculation method (hereinafter referred to as a “Comparative Example”). FIG. 6 is a graph showing a cumulative pitch error measured on the workpiece gear having 31 teeth, and FIG. 7 is a graph showing a cumulative pitch error measured on the workpiece gear having 208 teeth. As shown in these graphs, the cumulative pitch error is a small value for each of the workpiece gears having 31 teeth and 208 teeth.

Phases calculated using Working Example 1, Working Example 2, and the Comparative Example for these workpiece gears having 31 teeth and 208 teeth are shown in Table 1.

TABLE 1

| | Phase (31 teeth) | Phase (208 teeth) |
|---|---|---|
| Working Example 1 [deg] | 8.2747 | 1.2682 |
| Working Example 2 [deg] | 8.2748 | 1.2682 |
| Comparative Example [deg] | 8.2646 | 1.2645 |

As shown in Table 1, both the phases calculated using Working Example 1 and Working Example 2 are values that are extremely close to the Comparative Example.

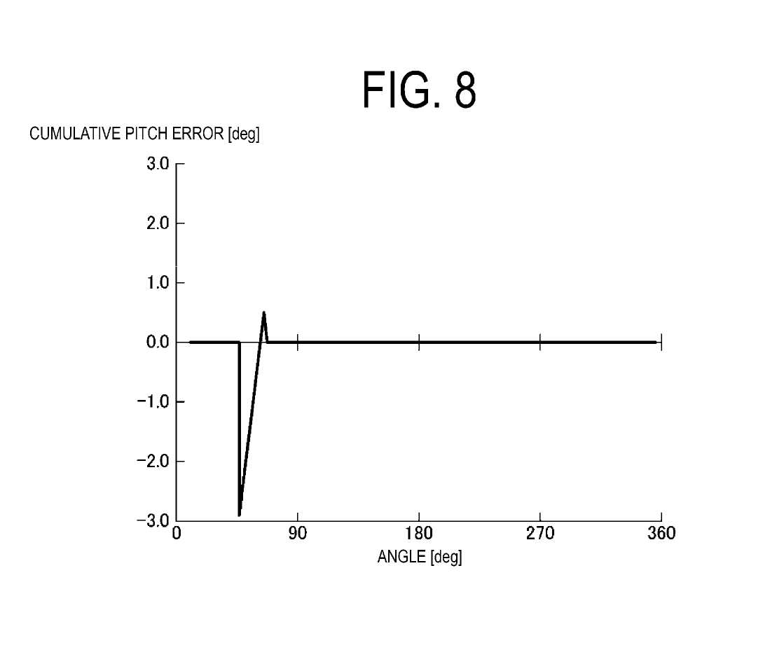

Further, the inventor et al. simulated a situation in which there was a lot of noise in a signal output from a displacement sensor and the calculated cumulative pitch error became large, and compared the phases calculated using the methods of Working Example 1, Working Example 2 and the Comparative Example with the phase of the gear set for the purpose of the simulation. FIG. 8 is data of the simulated cumulative pitch error. As shown in FIG. 8, in the present examination, a simulation was made where the cumulative pitch error partly includes significant noise due to the influence of the noise in the signal.

The phase assumed at the time of the simulation, and the phases calculated using the methods of Working Example 1, Working Example 2, and the Comparative Example are shown in Table 2.

TABLE 2

| | |
|---|---|
| Assumed phase [deg] | 12.0000 |
| Working Example 1 [deg] | 12.0086 |
| Working Example 2 [deg] | 11.9400 |
| Comparative Example [deg] | 10.8000 |

As shown in Table 2, in the Comparative Example, a difference of 1.2 degrees arises in relation to the assumed phase. In contrast to this, in the method of Working Example 1, a difference of 0.0086 degrees arises in relation to the assumed phase, which is an extremely small value. Further, in the method of Working Example 2, a difference of 0.06 degrees arises in relation to the assumed phase, which is an extremely small value in comparison to the Comparative Example.

As described above, as a result of the present examination, it is clearly demonstrated that a phase of a workpiece gear can be calculated with an extremely high degree of accuracy according to the above-described first embodiment and second embodiment, in comparison to conventional methods.

### REFERENCE SIGNS LIST

1 Gear machining apparatus
2 Gear support mechanism
4 Gear teeth grinding mechanism
6 Workpiece gear
8 Rotating shaft
10 Rotating shaft
12 Grinding member
20 Phase calculation device
22 Displacement sensor
24 Amplifier
26 Encoder
28 Measuring unit

1. A method for calculating a phase of teeth of a gear, the gear having Z number of teeth, the method comprising of:
a gear teeth amplitude signal acquiring step of acquiring a gear teeth amplitude signal (S(c)) corresponding to at least one revolution of the gear, the gear teeth amplitude signal (S(c)) being formed by an association of an angle (c) of the gear and a value corresponding to irregularities on an outer circumference of the gear within the angle (c);
a phase calculating step of calculating a phase (B) of an angular pitch (P) of the gear in accordance with the number (Z) of teeth when the gear teeth amplitude signal (S(c)) is subjected to frequency decomposition; and
a gear meshing angle calculating step of calculating a gear meshing angle on the basis of the phase (B) calculated in the phase calculating step.

2. The method for calculating a phase of teeth of a gear according to claim 1, wherein
in the phase calculating step, the phase (B) of the angular pitch (P) of the gear in accordance with the number (Z) of teeth is calculated by approximating to zero a difference between a cumulative pitch error of a front tooth surface of each of the teeth and an average value of the cumulative pitch errors of the front tooth surfaces of all the teeth and a difference between a cumulative pitch error of a rear tooth surface of each of the teeth and an average value of the cumulative pitch errors of the rear tooth surfaces of all the teeth, the cumulative pitch error being a difference between a theoretical angle position of the front tooth surface of each of the teeth and an angle position of the front tooth surface of each of the teeth or a difference between a theoretical angle position of the rear tooth surface of each of the teeth and an angle position of the rear tooth surface of each of the teeth, the theoretical angle position being determined taking a front tooth surface or a rear tooth surface of a predetermined tooth as reference, and the angle position being determined on the basis of the gear teeth amplitude signal.

3. The method for calculating a phase of teeth of a gear according to claim 1, wherein
in the phase calculating step, the phase (B) is calculated on the basis of angle positions of front and rear tooth surfaces of a predetermined tooth and an average value of cumulative pitch errors of the front and rear tooth surfaces of all the teeth.

4. The method for calculating a phase of teeth of a gear according to claim 1, wherein
in the gear teeth amplitude signal acquiring step, the gear teeth amplitude signal (S(c)) is acquired such that the angle (c) is a predetermined value when the angle (c) corresponds to a position between both tooth surfaces of a tooth of the gear and the angle (c) is zero when the angle (c) corresponds to a position between adjacent teeth of the gear, and
in the phase calculating step, the phase (B) is calculated on the basis of the following formulas:
$$C [ 2 j ] = C [ 0 ] + j * 360 / Z + e [ 2 j ] \\ C [ 2 j + 1 ] = C [ 1 ] + j * 360 / Z + e [ 2 j + 1 ] \\ Ea [ 1 ] = \frac{1}{Z} {\sum }_{j = 0}^{Z 1} ( e [ 2 j + 1 ] ) \\ Ea [ 0 ] = \frac{1}{Z} {\sum }_{j = 0}^{Z - 1} ( e [ 2 j ] ) \\ B \approx ( C [ 0 ] + C [ 1 ] + Ea [ 0 ] + Ea [ 1 ] ) / 2 \qquad [ Formulas 1 ]$$
where B represents the phase, j (from 0 to Z−1) represents a tooth number for identifying each of the teeth, and C[2j] and C[2j+1] represent front and rear angles of the tooth surfaces of the tooth number j.

5. The method for calculating a phase of teeth of a gear according to claim 1, wherein
in the phase calculating step, the phase (B) of the angular pitch (P) of the gear in accordance with the number (Z) of teeth is obtained by performing Fourier transform on the gear teeth amplitude signal (S(c)).

6. The method for calculating a phase of teeth of a gear according to claim 1, wherein
in the phase calculating step, the phase (B) is calculated on the basis of the following formulas:
$$B = \frac{360}{2 π Z} * a tan ( \frac{b ( z )}{a ( z )} ) \\ a ( Z ) = \frac{2}{360} {\int }_{0}^{360} S ( c ) cos ( \frac{2 π Zc}{360} ) d c \\ b ( Z ) = \frac{2}{360} {\int }_{0}^{360} S ( c ) sin ( \frac{2 π Zc}{360} ) d c \qquad [ Formulas 2 ]$$
where B represents the phase, and Z represents the number of teeth of the gear.

7. A gear teeth phase calculation device for calculating a phase of teeth of a gear, the gear having Z number of teeth, the gear teeth phase calculation device comprising:
gear teeth amplitude signal acquiring means for acquiring a gear teeth amplitude signal (S(c)) corresponding to at least one revolution of the gear, the gear teeth amplitude signal (S(c)) being formed by an association of an angle (c) of the gear and a value corresponding to irregularities on an outer circumference of the gear within the angle (c);
phase calculating means for calculating a phase of an angular pitch (P) of the gear in accordance with the number (Z) of teeth when the gear teeth amplitude signal (S(c)) is subjected to frequency decomposition; and
gear meshing angle calculating means for calculating a gear meshing angle on the basis of the phase calculated by the phase calculating means.

8. A gear machining apparatus comprising:
the gear teeth phase calculation device according to claim 7; and
a machining device configured to adjust a position of the gear on the basis of a phase of teeth of the gear detected by the gear teeth phase calculation device, and to machine the gear.
